(19) United States
(12) Patent Application Publication
(10) Pub. No.: US 2026/0366645 A1
(43) Pub. Date: Nov. 19, 2026

(54) APPARATUS AND METHOD FOR DIAGNOSING PERFORMANCE DEGRADATION OF CONTROL VALVE

(71) Applicant: ELECTRONICS AND TELECOMMUNICATIONS RESEARCH INSTITUTE, Daejeon (KR)

(72) Inventor: Jongwoo CHOI, Daejeon (KR)

(21) Appl. No.: 19/639,642

(22) Filed: Apr. 6, 2026

(30) Foreign Application Priority Data
May 15, 2025 (KR) 10-2025-0063353

(51) Int. Cl. F16K 37/00

(52) U.S. Cl. CPC F16K 37/005

(57) ABSTRACT

An apparatus for diagnosing performance degradation of a control valve installed in a pipeline, includes: a pressure sensor for measuring a pressure of a fluid flowing inside the pipeline; a flow sensor for measuring a flow rate of the fluid; and a processor configured to calculate current performance information of the control valve based on a flow coefficient and a characteristic curve of the control valve which are calculated depending on the pressure, the flow rate, and an opening degree of the control valve, and to diagnose performance degradation of the control valve by comparing pre-stored initial specification information with the current performance information.

### CROSS-REFERENCE TO RELATED APPLICATION

This application claims the benefit of Korean Patent Application No. 10-2025-0063353, filed on May 15, 2025, in the Korean Intellectual Property Office, the disclosure of which is incorporated herein by reference in its entirety.

### TECHNICAL FIELD

The present disclosure relates to an apparatus and method for diagnosing performance degradation of a control valve installed in a pipeline.

### BACKGROUND

A control valve is an important device used to control the flow of a fluid in a pipeline. Control valves are widely used in various industrial fields, including general piping equipment, as well as power plants, chemical processes, and oil refining plants.

In managing piping equipment, the management of a control valve is typically performed by simply checking for the occurrence of a failure. A method for determining whether a failure of the control valve has occurred may include checking for the occurrence of a leak or checking for a change in opening degree according to a control command.

However, such management methods are limited because they may only identify critical defects rendering the operation of the control valve impossible, and may not determine the performance degradation of the control valve.

A control valve, like other components of piping equipment, degrades in performance over time. Such performance degradation of a control valve is a problem directly affecting the efficiency and safety of the piping equipment in which the control valve is installed and the entire process.

To diagnose the performance degradation of a control valve, a physical inspection may be performed by disassembling the valve at regular intervals as a regular equipment inspection method, the performance may be checked by testing the operation of the valve at a specific point in time as an intermittent performance check method, or a subjective determination may be performed based on the experience of a piping equipment operator as an empirical determination method.

However, these diagnostic methods have a problem in that capturing real-time performance changes is difficult until a regular or intermittent diagnosis is made, and an industrial process in which the piping equipment was used needs to be stopped for the diagnosis. Furthermore, these diagnostic methods have problems in that there is a possibility of human error by the operator performing the diagnosis, and it is difficult to detect minute performance changes.

The background technology of the present disclosure is disclosed in Korean Patent Application Publication No. 10-2011-0014396 (Published on Feb. 11, 2011).

### SUMMARY

An object of the present disclosure is to provide an apparatus and a method for diagnosing performance degradation of a control valve, which are capable of diagnosing performance deterioration of the control valve based on a pressure gauge and a flow meter, in order to effectively manage a control valve installed in a pipeline

In accordance with a first aspect of the present disclosure, there is provided an apparatus for diagnosing performance degradation of a control valve installed in a pipeline, including: a pressure sensor for measuring a pressure of a fluid flowing inside the pipeline; a flow sensor for measuring a flow rate of the fluid; and a processor configured to calculate current performance information of the control valve based on a flow coefficient and a characteristic curve of the control valve which are calculated depending on the pressure, the flow rate, and an opening degree of the control valve, and to diagnose performance degradation of the control valve by comparing pre-stored initial specification information with the current performance information.

Further, the processor may be configured to calculate the characteristic curve based on a change in the flow coefficient according to the opening degree.

Further, the processor may be configured to calculate the flow coefficient using a density of the fluid, a pressure drop according to a difference between an inlet pressure and an outlet pressure of the control valve, and the flow rate.

Further, the processor may be configured to calculate a density of the fluid based on the pressure and a temperature of the fluid measured by a temperature sensor installed in the pipe line, or by referring to pre-stored general physical property information of the fluid.

Further, the processor may be configured to compare an initial characteristic curve according to the initial specification information with a current characteristic curve according to the current performance information, and calculate a difference in the flow coefficient between the initial characteristic curve and the current characteristic curve as the performance degradation of the control valve.

Further, the processor may be configured to calculate and compare an initial flow coefficient and a current flow coefficient at an arbitrary opening degree or a specific opening degree based on the initial specification information and the current performance information, and determine at least one of an average value, a median value, and a percentile of a difference value therebetween as the performance degradation of the control valve.

Further, the processor may be configured to compare the initial characteristic curve and the current characteristic curve, and determine, as the performance degradation of the control valve, whether a difference in the flow coefficients exceeds a predetermined value, a number of times the predetermined value has been exceeded, or a frequency of exceeding the predetermined value.

Further, the processor may be configured to calculate degradation of opening performance and degradation of closing performance of the control valve according to the opening degree.

In accordance with a second aspect of the present disclosure, there is provided a method for diagnosing performance degradation of a control valve, including: receiving a pressure and a flow rate of a fluid flowing inside a pipeline from a sensor installed in the pipeline in which the control valve is installed; calculating, by a processor, a flow coefficient of the control valve; deriving, by the processor, a characteristic curve of the control valve based on an opening degree of the control valve and the flow coefficient to calculate current performance information of the control valve; and diagnosing, by the processor, performance degradation of the control valve by comparing pre-stored initial specification information with the current performance information.

Further, in the operation of calculating the flow coefficient of the control valve, the processor may calculate the flow coefficient using a density of the fluid, a pressure drop according to a difference between an inlet pressure and an outlet pressure of the control valve, and the flow rate.

Further, the calculating of the flow coefficient of the control valve may include: calculating, by the processor, the density of the fluid based on the pressure and a temperature of the fluid measured by a temperature sensor installed in the pipeline, or by referring to pre-stored general physical property information of the fluid.

Further, in the operation of calculating the current performance information of the control valve, the processor may calculate the characteristic curve based on a change in the flow coefficient according to the opening degree.

Further, in the operation of diagnosing the performance degradation of the control valve, the processor may compare an initial characteristic curve according to the initial specification information with a current characteristic curve according to the current performance information, and calculate a difference in the flow coefficient for the two curves as the performance degradation of the control valve.

Further, in the operation of diagnosing the performance degradation of the control valve, the processor may calculate and compare an initial flow coefficient and a current flow coefficient at an arbitrary opening degree or a specific opening degree based on the initial specification information and the current performance information, and determine at least one of an average value, a median value, and a percentile of a difference value therebetween as the performance degradation of the control valve.

Further, in the operation of diagnosing the performance degradation of the control valve, the processor may compare the initial characteristic curve and the current characteristic curve, and determine, as the performance degradation of the control valve, whether a difference in the flow coefficients exceeds a predetermined value, a number of times the predetermined value has been exceeded, and a frequency of exceeding the predetermined value.

Further, in the operation of diagnosing the performance degradation of the control valve, the processor may calculate degradation of opening performance and degradation of closing performance of the control valve based on the opening degree.

In accordance with a third aspect of the present disclosure, there is provided a non-transitory computer-readable storage medium storing instructions that, when executed by one or more processors, cause the one or more processors to perform operations including: receiving, from a sensor installed in a pipeline in which a control valve is installed, a pressure and a flow rate of a fluid flowing inside the pipeline; calculating a flow coefficient of the control valve based on the received pressure and the flow rate; deriving a characteristic curve of the control valve based on an opening degree of the control valve and the flow coefficient, and calculating current performance information of the control valve; and diagnosing performance degradation of the control valve by comparing pre-stored initial specification information with the current performance information.

An apparatus and method for diagnosing performance degradation of a control valve according to an aspect of the present disclosure may diagnose the performance degradation of a control valve installed in a pipeline to control the flow of a fluid, thereby effectively operating and managing the control valve, and may improve the efficiency and stability of a piping facility or process employing the control valve.

An apparatus and method for diagnosing performance degradation of a control valve according to an aspect of the present disclosure may diagnose performance degradation in real time without stopping a facility or process, based on a pressure sensor and a flow sensor.

An apparatus and method for diagnosing performance degradation of a control valve according to an aspect of the present disclosure may derive a diagnosis result for the performance degradation of the control valve as numerical information to determine an objective degradation level.

An apparatus and method for diagnosing performance degradation of a control valve according to an aspect of the present disclosure may correct management information for the control valve by comparing it with initial specification information provided by a manufacturer based on a diagnosis result, and may perform preventive maintenance or predictive maintenance through statistical analysis or future prediction of the degradation level.

### BRIEF DESCRIPTION OF THE DRAWINGS

FIG. 1 is a diagram illustrating an apparatus for diagnosing performance degradation of a control valve and piping equipment according to an embodiment of the present disclosure.

FIG. 2 is a block diagram schematically illustrating a control configuration of the apparatus for diagnosing performance degradation of the control valve according to the embodiment of the present disclosure.

FIG. 3 is a diagram illustrating an operation flow of the apparatus for diagnosing performance degradation of the control valve according to the embodiment of the present disclosure.

FIG. 4 is a flowchart illustrating a diagnostic method of the apparatus for diagnosing performance degradation of the control valve according to the embodiment of the present disclosure.

FIG. 5 is an exemplary diagram illustrating performance degradation of a control valve according to the embodiment of the present disclosure.

### DETAILED DESCRIPTION

Hereinafter, embodiments of an apparatus and method for diagnosing performance degradation of a control valve according to the present disclosure will be described. In this process, the thickness of lines or the size of components shown in the drawings may be exaggerated for clarity and convenience of description. Furthermore, the terms described below are defined in consideration of their functions in the present disclosure and may vary according to the intention or custom of a user or operator. Therefore, the definitions of these terms should be made based on the content throughout the present specification.

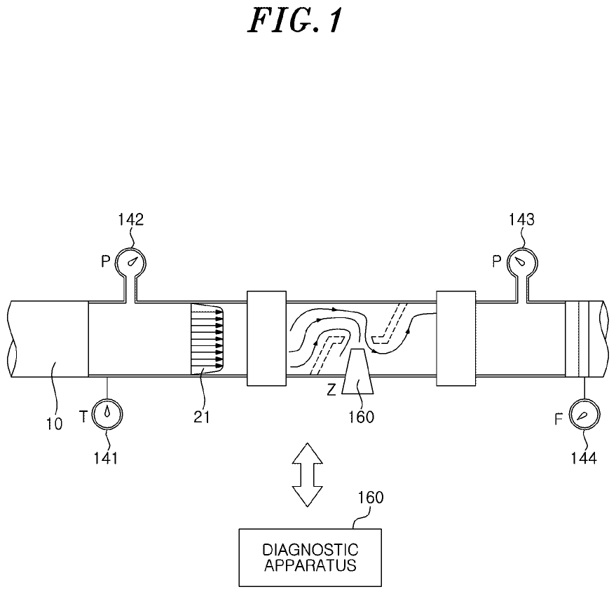

FIG. 1 is a diagram illustrating an apparatus for diagnosing performance degradation of a control valve and piping equipment according to an embodiment of the present disclosure.

Referring to FIG. 1, a control valve 160 for controlling the flow rate of a liquid-state fluid 21 flowing inside a pipeline 10 may be installed in the pipeline 10.

For example, the liquid-state fluid 21 may be water or oil, but is not limited thereto. The pipeline 10 may be water supply piping equipment, sewage piping equipment, and oil refining process piping equipment, but is not limited thereto.

The control valve 160 may control the flow rate and pressure drop of the fluid 21 passing through the control valve 160 by adjusting an opening degree, the level to which the valve is open. For example, as the control valve 160, a globe valve, a ball valve, and a butterfly valve may be used, but the present disclosure is not limited to these.

An apparatus for diagnosing performance degradation of a control valve (hereinafter, diagnostic apparatus) 100 according to the embodiment of the present disclosure may diagnose the performance degradation of the control valve 160 by using a plurality of sensors installed in the pipeline.

A first pressure sensor 142 and a second pressure sensor 143 may be installed at an inlet and an outlet of the control valve 160 installed in the pipeline 10, respectively. The first pressure sensor 142 may be installed at the inlet of the control valve 160 to measure the pressure of the fluid 21 flowing into the control valve 160, and the second pressure sensor 143 may be installed at the outlet of the control valve 160 to measure the pressure of the fluid 21 having passed through the control valve 160.

Furthermore, a temperature sensor 141 for measuring the temperature of the fluid 21 passing through the control valve 160 and a flow sensor 144 for measuring the flow rate of the fluid 21 may be installed in the pipeline 10.

The diagnostic apparatus 100 may diagnose the performance degradation of the control valve 160 by receiving data measured from the temperature sensor 141, the first pressure sensor 142, the second pressure sensor 143, and the flow sensor 144.

The diagnostic apparatus 100 calculates a difference between the pressure of the fluid 21 flowing into the control valve 160 and the pressure of the fluid 21 discharged from the control valve 160, based on the pressures measured by the first pressure sensor 142 and the second pressure sensor 143 among the plurality of sensors.

Furthermore, the diagnostic apparatus 100 may measure the flow rate of the fluid 21 passing through the control valve 160 via the flow sensor 144.

The diagnostic apparatus 100 may diagnose the performance degradation of the control valve 160 based on the temperature, pressure, and flow rate of the fluid 21 flowing inside the pipeline 10. The diagnostic apparatus 100 may diagnose the performance degradation of the control valve 160 and may calculate and output the diagnosis result numerically.

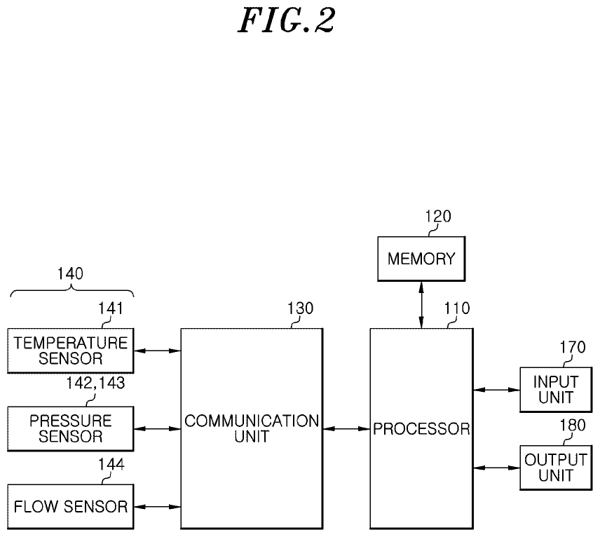

FIG. 2 is a block diagram schematically illustrating a control configuration of the apparatus for diagnosing performance degradation of the control valve according to the embodiment of the present disclosure.

Referring to FIG. 2, the diagnostic apparatus 100 may include a memory 120, a communication unit 130, a sensor 140, an input unit 170, an output unit 180, and a processor 110.

The memory 120 may store data received from the sensor 140, and may store data calculated in a process of determining the performance degradation of the control valve 160 and diagnosis result data regarding the performance degradation of the control valve 160. Furthermore, the memory 120 may store initial specification information and current performance information for the diagnosis of the control valve 160. Furthermore, the memory 120 may store general physical property information of the fluid for calculating the density of the fluid.

The memory 120 may store data for all or part of an algorithm for determining the performance of the control valve 160 and calculating the degree of degradation.

For example, the memory 120 may include storage means such as a non-volatile memory like random access memory (RAM), read-only memory (ROM), and electrically erasable programmable ROM (EEPROM), a flash memory, an HDD, an SDD, and an SSD.

The communication unit 130 may communicate with a plurality of sensors 140 (141 to 144) to receive measured data therefrom. Furthermore, the communication unit 130 may communicate with an external management server (not shown) or a terminal (not shown).

The communication unit 130 may transmit and receive using various methods such as wired/wireless analog signals and digital signals, and protocols corresponding thereto.

For example, the communication unit 130 may communicate using communication methods such as serial communication, Ethernet, Wi-Fi, Bluetooth, and mobile communication.

The sensor 140 may be provided in plurality and installed in the pipeline 10. The sensor 140 may include the temperature sensor 141, the first pressure sensor 142, the second pressure sensor 143, and the flow sensor 144.

The temperature sensor 141 may be installed in the pipeline 10 to measure the temperature of the fluid 21 flowing through the control valve 160. The first pressure sensor 142 and the second pressure sensor 143 may measure the pressure of the fluid 21 flowing into the control valve 160 and the pressure of the fluid 21 discharged from the control valve 160, respectively. The flow sensor 144 may measure the flow rate of the fluid 21 passing through the control valve 160.

The input unit 170 may receive data for controlling the control valve 160 and diagnosing performance thereof. For example, the input unit 170 may include at least one input means among a switch, a button, and a touchpad.

The output unit 180 may output a diagnosis progress status and a diagnosis result regarding the performance degradation of the control valve 160. Furthermore, the output unit 180 may output data measured from the plurality of sensors 141 to 144 together with the diagnosis result. For example, the output unit 180 may include output means such as a communication interface, an LED lamp, a display, and a speaker.

The output unit 180 may output the status information in at least one form selected from data, sound effects, warning sounds, voice guidance, text messages, images, videos, status lights, and warning lights during the process of diagnosing the performance degradation of the control valve 160.

The processor 110 may include at least one microprocessor and may operate based on data stored in the memory 120. For example, the processor 110 may be implemented in various hardware and corresponding software-driven ways, such as a microcontroller unit (MCU), a system on chip (SoC), a general computing device, an edge device, or a cloud server.

The processor 110 may store data received through the communication unit 130 in the memory 120, and may control operations based on the data stored in the memory 120.

The processor 110 may determine the performance of the control valve 160 installed in the pipeline 10 based on data measured from the plurality of sensors 141 to 144, and may calculate the degree of performance degradation. The processor 110 may determine the performance degradation of the control valve 160 in real time using the flow sensor and the pressure sensor without a separate stop of facility operation while the fluid 21 is flowing in the pipeline 10. The processor 110 may calculate a valve characteristic curve and a flow coefficient to diagnose the performance degradation of the control valve 160. The processor 110 may diagnose the degradation of opening performance and the degradation of closing performance of the control valve 160.

The processor 110 may generate a diagnosis result for the performance degradation of the control valve 160, store it in the memory 120, and output the diagnosis result through the output unit 180.

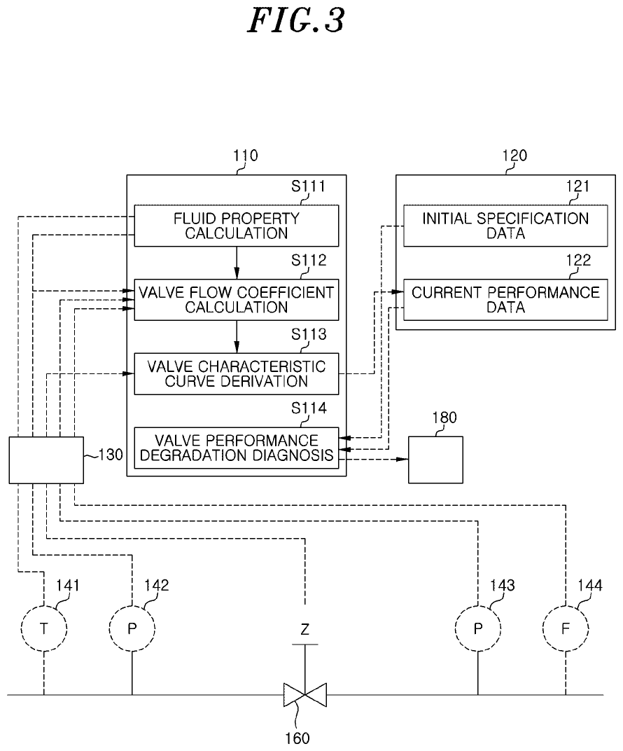

FIG. 3 is a diagram illustrating an operation flow of the apparatus for diagnosing performance degradation of the control valve according to the embodiment of the present disclosure.

Referring to FIG. 3, the sensor 140 may be installed in the pipeline 10 to measure data for calculating the performance of the control valve 160.

For example, the temperature sensor 141 may be installed in the pipeline 10 to measure the temperature (T) of the fluid 21 flowing in the pipeline 10 and the control valve 160. The first pressure sensor 142 and the second pressure sensor 143 may measure the pressure (P) of the fluid 21 flowing inside the pipeline 10. At this time, the first pressure sensor 142 may be installed at the inlet of the control valve 160 to measure the inlet pressure (Pᵢₙₗₑₜ) of the fluid 21, and the second pressure sensor 143 may be installed at the outlet of the control valve 160 to measure the outlet pressure (Pₒᵤₜₗₑₜ) of the fluid 21. Furthermore, the flow sensor 144 may measure the flow rate (Q) of the fluid 21 passing through the control valve 160.

Meanwhile, the control valve 160 may transmit the opening degree of the valve, that is, the opening degree (z), to the communication unit 130. The opening degree (z) may be a value representing the extent to which the control valve is open as a percentage, based on the fully open and fully closed states of the control valve 160. The opening degree (z) may be a control value for controlling the opening degree, or it may be a measured value. For example, the opening degree (z) may be measured by a method such as analyzing a signal of a valve positioner (not shown) or measuring the position of a valve stem (not shown).

The communication unit 130 may receive data measured from the plurality of sensors 141 to 144, that is, the temperature sensor 141, the first pressure sensor 142 and the second pressure sensor 143, and the flow sensor 144 installed in the pipeline 10, and may receive data of the control valve 160. The communication unit 130 may apply the data received from the sensor 140 to the processor 110.

The processor 110 analyzes the data received from the communication unit 130 and performs a calculation for diagnosing the performance degradation of the control valve 160.

The processor 110 may calculate physical properties of the fluid based on the data received from the communication unit 130 (S111).

The processor 110 may calculate the physical properties of the fluid 21 using the temperature (T) from the temperature sensor 141 and the pressure (P) from the first pressure sensor 142 and the second pressure sensor 143. For example, the physical property of the fluid to be calculated may be density.

If the temperature sensor 141 is not installed in the pipeline 10 or to reduce the calculation load, the processor 110 may not calculate the physical properties of the fluid 21 but may use the general physical property values of the fluid 21 instead. For example, in the case of a water purification pipeline, the processor 110 may use 1000 kg/m³, which is the general density of water, as the physical property value of the fluid 21.

The processor 110 may calculate the flow coefficient of the control valve 160 (S112).

The processor 110 may calculate the current performance of the control valve 160 presumed to have degraded using the physical properties of the fluid 21, the pressure data (P) from the first pressure sensor 142 and the second pressure sensor 143, and the flow rate data (F) from the flow sensor 144.

Here, the performance of the control valve 160 may be the flow coefficient of the control valve 160. The processor 110 may calculate the performance of the control valve 160 based on the following Equation 1.

$$\begin{matrix}{C}_{v} = Q \sqrt{\frac{SG}{Δ P}} \\ = Q \sqrt{\frac{ρ / {ρ}_{reference}}{{P}_{inlet} - {P}_{outlet}}}\end{matrix} \qquad ( Equation 1 )$$

Here, Cv is the flow coefficient calculated in United States customary units, and SG is the specific gravity, corresponding to the value obtained by dividing the density of the fluid ρ by a reference density ρ_{reference}. Here, for the reference density, 1000 kg/m³, the general density of water, may be used. ΔP is the pressure drop caused by the control valve 160, and it is the difference between the inlet pressure Pᵢₙₗₑₜ and the outlet pressure Pₒᵤₜₗₑₜ, which are values in psi measured using the first pressure sensor 142 and the second pressure sensor 143. Q corresponds to the flow rate passing through the control valve 160, which is a value in GPM measured using the flow sensor 144.

Furthermore, the processor 110 may also calculate the performance of the control valve 160 based on the following Equation 2.

$$\begin{matrix}{K}_{v} = Q \sqrt{\frac{SG}{Δ P}} \\ = Q \sqrt{\frac{ρ / {ρ}_{reference}}{{P}_{inlet} - {P}_{outlet}}}\end{matrix} \qquad ( Equation 2 )$$

Here, Kv signifies the flow factor calculated using the SI unit system. For the units of pressure P and flow rate Q, bar and m³/h may be used, respectively.

The processor 110 may derive the characteristic curve of the valve (S113).

The processor 110 may derive the performance information of the control valve 160 under various operating conditions as a characteristic curve. Here, the performance of the control valve may be the aforementioned flow coefficient, and the various operating conditions may be the opening degree (z) of the control valve 160. The processor 110 may derive the characteristic curve of the control valve, corresponding to the relationship between the opening degree (z) of the control valve 160 and its flow coefficient (Cv or Kv), as the current performance information of the control valve.

The processor 110 may store the flow coefficient and characteristic curve of the control valve 160 in the memory 120 as the current performance information of the control valve 160.

The processor 110 may diagnose the valve performance degradation (S114).

The processor 110 may calculate the degree of performance degradation by comparing the initial specifications of the control valve 160 with the current performance calculated based on the data measured from the sensor 140.

For example, the processor 110 may compare the initial characteristic curve and the current characteristic curve to derive the distance between the two curves as a result of the performance degradation diagnosis. The processor 110 may compare the initial flow coefficient and the current flow coefficient at an arbitrary opening degree or a specific reference opening degree to derive the difference as a result of the performance degradation diagnosis. The processor 110 may compare the initial flow coefficient and the current flow coefficient at an arbitrary opening degree or a specific reference opening degree to derive a result value for at least one of the average value, median value, and percentile of the difference as a result of the performance degradation diagnosis. In addition, the processor 110 may calculate a diagnosis result for performance degradation based on whether a result obtained by comparing the initial characteristic curve with the current characteristic curve exceeds a preset value, a number of times the preset value is exceeded, and a frequency thereof.

The processor 110 may store the diagnosis result for the performance degradation of the control valve 160 in the memory 120 and output it through the output unit 180. In some cases, the processor 110 may transmit the diagnosis result to an external server or terminal through the communication unit 130.

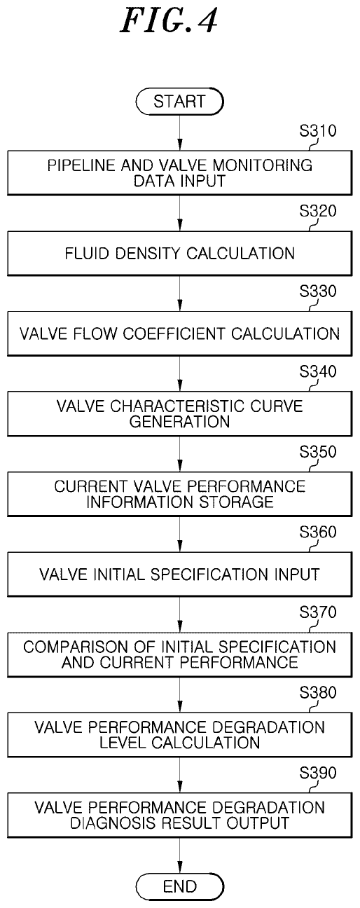

FIG. 4 is a flowchart illustrating a diagnostic method of the apparatus for diagnosing performance degradation of the control valve according to the embodiment of the present disclosure.

Referring to FIG. 4, the processor 110 may receive pipeline and valve monitoring information from the sensor 140 installed in the pipeline 10 through the communication unit 130 (S310).

For example, the temperature sensor 141 may measure the temperature (T) of the fluid 21 flowing inside the pipeline 10, the first pressure sensor 142 and the second pressure sensor 143 may measure the inlet pressure (Pᵢₙₗₑₜ) and outlet pressure (Pₒᵤₜₗₑₜ) of the control valve 160, and the flow sensor 144 may measure the flow rate (F) of the fluid. Meanwhile, the control valve 160 may input the opening degree (z) to the processor 110.

The processor 110 may calculate the physical properties of the fluid 21 based on data received from the communication unit 130, for example, temperature data and pressure data (S320). Here, the physical property of the fluid 21 may be density. Meanwhile, if the temperature sensor 141 is not installed or if it is necessary to reduce the calculation load, the processor 110 may use the density of a general fluid as the physical property.

The processor 110 may calculate the valve flow coefficient based on the physical properties of the fluid 21, the pressure data, and the flow rate data (S330). For example, the processor 110 may calculate the flow coefficient (Cv) of the control valve calculated in United States customary units or the flow factor (Kv) of the control valve calculated in the SI unit system.

The processor 110 may derive the characteristic curve of the control valve based on the flow coefficient of the control valve 160 and data of the control valve 160 (S340).

For example, the processor 110 may calculate the characteristic curve of the control valve 160 by setting the opening degree (z) of the control valve 160 as an operating condition and the performance of the control valve as the flow coefficient. The processor 110 may calculate the characteristic curve of the control valve 160 by analyzing the relationship between the opening degree (z) and the flow coefficient Cv or Kv of the control valve, based on the change in the flow coefficient according to the opening degree (z) of the control valve 160.

The processor 110 may store the data related to the derived control valve characteristic curve in the memory 120 as the current performance information (S350).

The initial specification information 121 of the control valve 160 may be pre-stored in the memory 120. In some cases, if the initial specification information 121 is not stored, the processor 110 may receive the initial specification information 121 from the manufacturer's server of the control valve 160, or receive it through the input unit 170 and store it in the memory 120 (S360).

The processor 110 compares the initial specification information 121 of the control valve 160 stored in advance in the memory 120 with the current performance information 122 calculated based on data measured by the sensor 140 (S370). Based on the comparison result, the processor 110 may diagnose performance degradation of the valve 114 (S380).

The processor 110 may calculate the degree of performance degradation by comparing the initial specifications of the control valve 160 with the current performance calculated based on the data measured from the sensor 140.

For example, the processor 110 may diagnose the performance degradation as the distance between two curves by comparing an initial characteristic curve and a current characteristic curve, may diagnose the performance degradation as the difference by comparing an initial flow coefficient and a current flow coefficient at an arbitrary or specific reference opening degree, may diagnose the performance degradation by calculating at least one of an average value, a median value, and a percentile of the difference by comparing the initial flow coefficient and the current flow coefficient, and may diagnose the performance degradation based on whether the result of comparing the initial characteristic curve and the current characteristic curve exceeds a preset value, the number of times and a frequency with which the preset value is exceeded, and the like.

The processor 110 may output a diagnosis result for the performance degradation of the control valve 160 through the output unit 180 (S390). The processor 110 may output a graph of the characteristic curve of the control valve 160 or may output numerical data such as the flow coefficient.

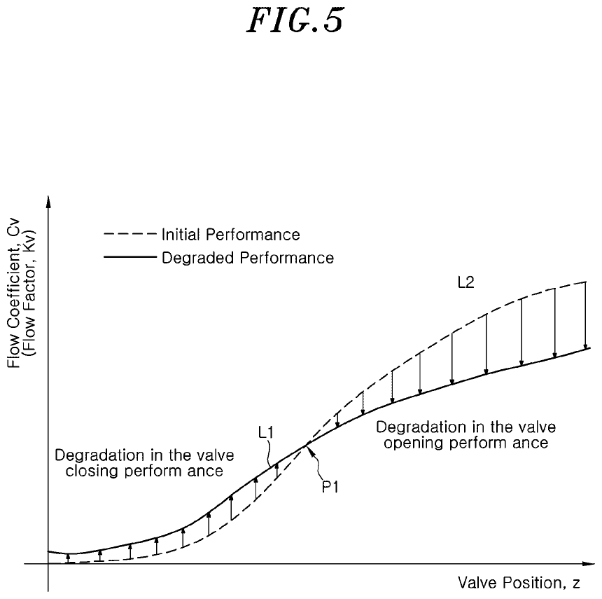

FIG. 5 is an exemplary diagram illustrating performance degradation of the control valve according to the embodiment of the present disclosure.

Referring to FIG. 5, the processor 110 may calculate the characteristic curve of the control valve 160 as the current performance information 122 and compare it with the initial specification information 121.

The processor 110 may calculate a current characteristic curve (L1) based on the change in the flow coefficient according to the opening degree (z) of the control valve 160, store it as the current performance information 122 of the control valve 160, and diagnose the performance degradation of the control valve 160 by comparing the current characteristic curve (L1) with an initial characteristic curve (L2) based on pre-stored initial specification information 121.

Assuming a general control valve 160, as the opening degree (z) of the control valve 160 corresponding to the x-axis increases, the closed control valve 160 may gradually open. At this time, as the control valve 160 opens, the flow rate passing through the control valve 160 increases, and the pressure drop between the inlet pressure and the outlet pressure of the control valve 160 may decrease, so the flow coefficient of the control valve 160 corresponding to the y-axis may increase.

The processor 110 may diagnose the performance degradation by calculating the difference between the initial characteristic curve (L2) and the current characteristic curve (L1) according to the position, i.e., the opening degree (z), of the control valve 160. For example, if internal structures of the control valve 160, such as a valve seat or a disc, are worn out because the control valve 160 has operated for a long time, flow may exist because the control valve 160 does not properly close even when the opening degree (z) of the control valve 160 is zero, so degradation of closing performance may occur. Furthermore, if deposits accumulate inside the control valve 160, the flow of the fluid 21 passing through the control valve 160 is obstructed by the deposits, so the flow rate when the control valve 160 is open decreases and the pressure drop increases, which may cause degradation of opening performance.

The processor 110 may diagnose the performance degradation of the closing performance and opening performance of the control valve 160 in this manner, based on the difference obtained by comparing the initial characteristic curve (L2) according to the initial specification information of the control valve 160 with the current characteristic curve (L1) according to the current performance information.

In this case, with respect to an intersection point (P1) at which the initial characteristic curve (L2) and the current characteristic curve (L1) intersect, a region on the left side indicates degradation in closing performance, and a region on the right side indicates degradation in opening performance. When degradation occurs, a flow coefficient in a state where the control valve 160 is closing has a value greater than a flow coefficient according to the initial specification information, and a flow coefficient in a state where the control valve 160 is opening has a value smaller than a flow coefficient according to the initial specification information.

The processor 110 may calculate a difference between the flow coefficients according to the current characteristic curve L1 and the initial characteristic curve L2 based on an arbitrary opening degree, a specific opening degree, a plurality of opening degrees, and the like, and determine performance degradation of opening performance and closing performance of the control valve 160.

Accordingly, the apparatus and method for diagnosing performance degradation of the control valve according to an aspect of the present disclosure can easily diagnose the performance degradation of the control valve based on a flow sensor and a pressure sensor installed in a pipeline, may effectively operate and manage the control valve, and can improve the efficiency and stability of a piping facility or process to which the control valve is applied. Furthermore, the apparatus and method for diagnosing performance degradation of the control valve according to an aspect of the present disclosure can diagnose performance degradation continuously in real time without stopping a facility or process, and can derive a diagnosis result for the performance degradation of the control valve as numerical information to determine an objective degradation level.

The present disclosure has been described with reference to the embodiments shown in the drawings, but these are merely illustrative, and it will be understood by those skilled in the art that various modifications and other equivalent embodiments are possible therefrom. Therefore, the technical protection scope of the present disclosure should be determined by the patent claims below.

What is claimed is:

1. An apparatus for diagnosing performance degradation of a control valve installed in a pipeline, comprising:
a pressure sensor for measuring a pressure of a fluid flowing inside the pipeline;
a flow sensor for measuring a flow rate of the fluid; and
a processor configured to calculate current performance information of the control valve based on a flow coefficient and a characteristic curve of the control valve which are calculated depending on the pressure, the flow rate, and an opening degree of the control valve, and to diagnose performance degradation of the control valve by comparing pre-stored initial specification information with the current performance information.

2. The apparatus of claim 1, wherein the processor is configured to calculate the characteristic curve based on a change in the flow coefficient according to the opening degree.

3. The apparatus of claim 1, wherein the processor is configured to calculate the flow coefficient using a density of the fluid, a pressure drop according to a difference between an inlet pressure and an outlet pressure of the control valve, and the flow rate.

4. The apparatus of claim 2,
wherein the processor is configured to calculate a density of the fluid based on the pressure and a temperature of the fluid measured by a temperature sensor installed in the pipe line, or by referring to pre-stored general physical property information of the fluid.

5. The apparatus of claim 1, wherein the processor is configured to compare an initial characteristic curve according to the initial specification information with a current characteristic curve according to the current performance information, and calculate a difference in the flow coefficient between the initial characteristic curve and the current characteristic curve as the performance degradation of the control valve.

6. The apparatus of claim 5, wherein the processor is configured to calculate and compare an initial flow coefficient and a current flow coefficient at an arbitrary opening degree or a specific opening degree based on the initial specification information and the current performance information, and determine at least one of an average value, a median value, and a percentile of a difference value therebetween as the performance degradation of the control valve.

7. The apparatus of claim 5, wherein the processor is configured to compare the initial characteristic curve and the current characteristic curve, and determine, as the performance degradation of the control valve, whether a difference in the flow coefficients exceeds a predetermined value, a number of times the predetermined value has been exceeded, or a frequency of exceeding the predetermined value.

8. The apparatus of claim 5, wherein the processor is configured to calculate degradation of opening performance and degradation of closing performance of the control valve according to the opening degree.

9. A method for diagnosing performance degradation of a control valve, comprising:
receiving a pressure and a flow rate of a fluid flowing inside a pipeline from a sensor installed in the pipeline in which the control valve is installed;
calculating, by a processor, a flow coefficient of the control valve;
deriving, by the processor, a characteristic curve of the control valve based on an opening degree of the control valve and the flow coefficient to calculate current performance information of the control valve; and
diagnosing, by the processor, performance degradation of the control valve by comparing pre-stored initial specification information with the current performance information.

10. The method of claim 9, wherein, in the operation of calculating the flow coefficient of the control valve, the processor calculates the flow coefficient using a density of the fluid, a pressure drop according to a difference between an inlet pressure and an outlet pressure of the control valve, and the flow rate.

11. The method of claim 10, wherein the calculating of the flow coefficient of the control valve comprises:
calculating, by the processor, the density of the fluid based on the pressure and a temperature of the fluid measured by a temperature sensor installed in the pipeline, or by referring to pre-stored general physical property information of the fluid.

12. The method of claim 9, wherein, in the operation of calculating the current performance information of the control valve, the processor calculates the characteristic curve based on a change in the flow coefficient according to the opening degree.

13. The method of claim 9, wherein, in the operation of diagnosing the performance degradation of the control valve, the processor compares an initial characteristic curve according to the initial specification information with a current characteristic curve according to the current performance information, and calculates a difference in the flow coefficient for the two curves as the performance degradation of the control valve.

14. The method of claim 13, wherein, in the operation of diagnosing the performance degradation of the control valve, the processor calculates and compares an initial flow coefficient and a current flow coefficient at an arbitrary opening degree or a specific opening degree based on the initial specification information and the current performance information, and determines at least one of an average value, a median value, and a percentile of a difference value therebetween as the performance degradation of the control valve.

15. The method of claim 13, wherein, in the operation of diagnosing the performance degradation of the control valve, the processor compares the initial characteristic curve and the current characteristic curve, and determines, as the performance degradation of the control valve, whether a difference in the flow coefficients exceeds a predetermined value, a number of times the predetermined value has been exceeded, and a frequency of exceeding the predetermined value.

16. The method of claim 13, wherein, in the operation of diagnosing the performance degradation of the control valve, the processor calculates degradation of opening performance and degradation of closing performance of the control valve based on the opening degree.

17. A non-transitory computer-readable storage medium storing instructions that, when executed by one or more processors, cause the one or more processors to perform operations comprising:
receiving, from a sensor installed in a pipeline in which a control valve is installed, a pressure and a flow rate of a fluid flowing inside the pipeline;
calculating a flow coefficient of the control valve based on the received pressure and the flow rate;
deriving a characteristic curve of the control valve based on an opening degree of the control valve and the flow coefficient, and calculating current performance information of the control valve; and
diagnosing performance degradation of the control valve by comparing pre-stored initial specification information with the current performance information.
